(19) United States
(12) Patent Application Publication
(10) Pub. No.: US 2015/0304235 A1
(43) Pub. Date: Oct. 22, 2015

(54) ALLOCATING AND ACCESSING WEBSITE RESOURCES VIA DOMAIN NAME ROUTING RULES

(71) Applicant: Go Daddy Operating Company, LLC, Scottsdale, AZ (US)

(72) Inventor: Daymion T. Reynolds, Phoenix, AZ (US)

(73) Assignee: Go Daddy Operating Company, LLC, Scottsdale, AZ (US)

(21) Appl. No.: 14/255,863

(22) Filed: Apr. 17, 2014

(51) Int. Cl. H04L 12/911; H04L 12/24; H04L 12/741

(52) U.S. Cl. CPC H04L 47/781; H04L 45/74; H04L 41/082; H04L 41/0668

(57) ABSTRACT

Systems and methods are provided for allocating and accessing website resources via domain name routing rules as opposed to the domain name system (DNS). The system may include a reverse proxy server that includes domain name routing rules and a plurality of hosting servers. The reverse proxy server may receive a request from a client, wherein the request may comprise a domain name and possibly a path. The reverse proxy server may fulfill the request using the domain name routing rules for the domain name and possibly the path. The request may be, as non-limiting examples, to transfer a file to a requester, move a file from one server to another server, allocate redundant passive resources that may be activated in the event of an error, provide a website resource that may span two or more hosting servers and/or retrieve data from cache on the reverse proxy server.

### FIELD OF THE INVENTION

The present invention generally relates to the field of allocating and accessing website resources via domain name routing rules.

### SUMMARY OF THE INVENTION

The present invention provides systems and methods for a reverse proxy server to identify a domain name and optionally a path within an incoming request (such as an HTTP request). The reverse proxy server may fulfill the request on one or more hosting servers by, as non-limiting examples, configuring, load balancing and/or routing the request according to domain name routing rules for the domain name and optionally the path.

In one embodiment, a system for practicing the invention may comprise a plurality of hosting servers hosting a plurality of websites and a reverse proxy server comprising one or more hardware servers and software. The reverse proxy server may receive a request comprising a domain name. The software may comprise domain name routing rules which may be configured to receive the domain name and fulfill the request, possibly by locating a website or website resource stored on the plurality of hosting servers based on the domain name.

In another embodiment, a method for allocating and controlling resources on one or more hosting servers is provided. The method comprises one or more hardware servers registering a domain name to a client. One or more hosting servers, that have been set up, may provide hosting services to the client. A reverse proxy server may be configured so that the reverse proxy server will route incoming requests, such as HTTP requests, that include the domain name to the one or more hosting servers.

In another embodiment, the reverse proxy server may receive from a client an incoming request. The incoming request may include a domain name. The reverse proxy server may comprise software having domain name routing rules for a plurality of domain names. The reverse proxy server may fulfill the incoming request on one or more hosting servers using the domain name routing rules for the domain name in the incoming request.

In another embodiment, a method for providing redundancy and automatic failover is provided on a reverse proxy server for two or more hosting servers. As a specific example, the method may comprise the reverse proxy server setting domain name routing rules that indicate a first data is active and a second data is inactive on a first hosting server and the first data is inactive and the second data is active on a second hosting server. If an error is detected on the first server, for example, the reverse proxy server may set the domain name routing rules to indicate the first data and the second data are inactive on the first hosting server and the first data and the second data are active on the second hosting server. This may be accomplished without using the DNS which would cause a delay in a failover method.

In another embodiment, a method for account spanning is provided on two or more hosting servers. Hosting services may be provided to a client on the two or more hosting servers. A reverse proxy server may set domain name routing rules for a domain name, wherein the domain name in the domain name routing rules indicate that a website or website resource associated with the domain name spans the two or more hosting servers.

In another embodiment, a method for integrating a product and/or service is provided. A reverse proxy server, comprising one or more hardware servers and software, may receive an incoming request that includes a domain name and a path. The software may comprise domain name routing rules for a plurality of domain names, wherein one or more of the domain names in the plurality of domain names are associated with one or more paths. The reverse proxy server may fulfill the incoming request on one or more hosting servers using the domain name routing rules for the domain name and the path.

In another embodiment, a method of using cache on a reverse proxy server is provided. The reverse proxy server may receive a request from a requester that includes a domain name. The reverse proxy server may access data in the cache using domain name routing rules for the domain name. The data from the cache may be transmitted by the reverse proxy server to the requester.

It should be understood that teachings from any embodiment herein described may be combined with teachings from any other embodiment herein described, unless explicitly stated otherwise. As an example, any embodiment described herein using a domain name with domain name routing rules may also use a domain name and a path with the domain name routing rules. The above features and advantages of the present invention will be better understood from the following detailed description taken in conjunction with the accompanying drawings.

### BRIEF DESCRIPTION OF THE DRAWINGS

FIG. 1 is a block diagram of a system for allocating and accessing website resources or hosted content via domain name routing rules.

FIG. 2 is a block diagram of a system with redundancy and automatic failover capabilities using domain name routing rules.

FIG. 3 is a block diagram of a system with account server spanning capabilities using domain name routing rules.

FIG. 4 is a block diagram of a system with product and service integration using domain name routing rules.

FIG. 5 is a block diagram of a system with caching using domain name routing rules.

FIG. 6 is a flow diagram of a process for allocating and controlling website resources using domain name routing rules.

FIG. 7 is a is a flow diagram of the process illustrated in FIG. 6, with the additional steps of receiving and fulfilling an incoming request.

FIG. 8 is a flow diagram of another process for allocating and controlling website resources using domain name routing rules.

FIG. 9 is a first half of a flow diagram illustrating a method for redundancy and automatic failover for website resources using domain name routing rules.

FIG. 10 is a second half of a flow diagram illustrating a method for redundancy and automatic failover for website resources using domain name routing rules.

FIG. 11 is a flow diagram of additional steps that may be performed in combination with other embodiments.

FIG. 12 is a flow diagram of a process for account spanning using domain name routing rules.

FIG. 13 is a flow diagram of a process for product and service integration using domain name routing rules.

FIG. 14 is a flow diagram of a process for online caching of website resources using domain name routing rules.

FIG. 15 is a flow diagram of a process for online caching of website resources using domain name routing rules and product and services integration.

### DETAILED DESCRIPTION

The present invention will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

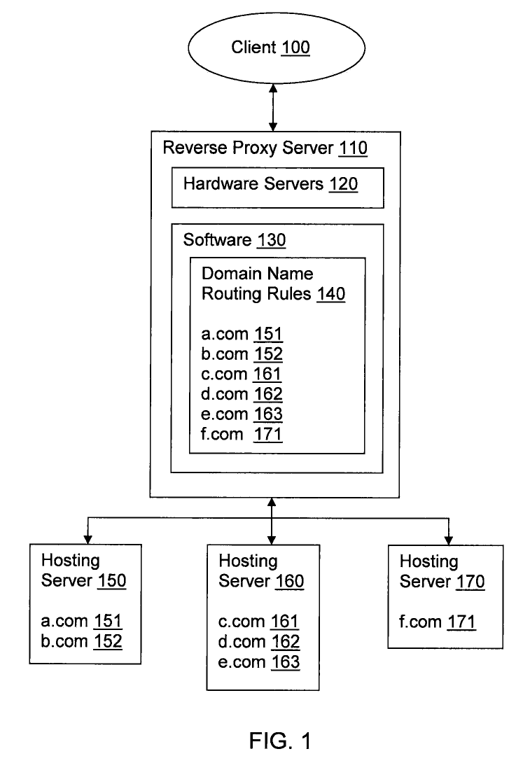

FIG. 1 is a block diagram of a system that may be used to practice the present invention. The client 100 may communicate with the reverse proxy server 110 and the reverse proxy server 110 may communicate with one or more hosting servers 150, 160, 170 over a computer network.

A computer network is a collection of links and nodes (e.g., multiple computers and/or other devices connected together) arranged so that information may be passed from one part of the computer network to another over multiple links and through various nodes. Examples of computer networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between clients 100 and website resources stored on hosting servers 150, 160, 170. Hundreds of millions of people (clients 100) around the world have access to computers connected to the Internet via Internet Service Providers (ISPs). Content providers place website resources, such as, as non-limiting examples, multimedia information (e.g., text, graphics, audio, video, animation, and other forms of data) at specific locations on the Internet which may be operated from hosting servers 150, 160, 170. The combination of all the websites, website resources and their corresponding web pages on the Internet are generally known as the World Wide Web (WWW) or simply the Web.

For clients 100 and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other. Clients 100 may use, as non-limiting examples, a cell phone, PDA, tablet, laptop computer, or desktop computer to access websites or servers, such as hosting servers 150, 160, 170 or reverse proxy servers 110 via a computer network, such as the Internet.

Prevalent on the Web are multimedia websites, some of which may offer and sell goods and services to individuals and organizations. Websites may consist of a single webpage, but typically consist of multiple interconnected and related webpages. Websites, unless very large and complex or have unusual traffic demands, typically reside on a single hosting server 150, 160, 170 and are prepared and maintained by a single individual or entity (although websites residing on multiple hosting servers are certainly possible). Menus, links, tabs, etc. may be used by clients 100 to move between different web pages within the website or to move to a different website, possibly on the same or a different hosting server 150, 160, 170.

Websites may be created using HyperText Markup Language (HTML) to generate a standard set of tags that define how the webpages for the website are to be displayed. Clients 100 on the Internet may access content providers' websites using software known as an Internet browser, such as MICROSOFT INTERNET EXPLORER, GOOGLE CHROME or MOZILLA FIREFOX. After the browser has located the desired webpage, the browser requests and receives information from the webpage, typically in the form of an HTML document, and then displays the webpage content for the client 100. The client 100 then may view other webpages at the same website or move to an entirely different website using the browser.

Some website operators, typically those that are larger and more sophisticated, may provide their own hardware, software, and connections to the Internet. But many website operators either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers 150, 160, 170.

The server or hosting server 150, 160, 170 comprise hardware servers and may be, as non-limiting examples, one or more Dell PowerEdge(s) rack server(s), HP Blade Servers, IBM Rack or Tower servers, although other types of servers and combinations of one or more servers may be used. Various software packages and applications may run on the servers 150, 160, 170 as desired.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website on the Internet through the use of a URL. The URL may include a Hypertext Transfer Protocol (HTTP) request combined with the website's Internet address, also known as the website's 104 domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a Top-Level Domain (TLD) and their corresponding IP addresses. For certain TLDs (e.g., .biz, .info, .name and .org) the Registry is also the authoritative source for contact information related to the domain name and is referred to as a “thick” Registry. For other TLDs (e.g., .com and .net) only the domain name, registrar identification, and name server information is stored within the Registry, and a Registrar is the authoritative source for the contact information related to the domain name. Such Registries are referred to as “thin” registries. Most gTLDs are organized through a central domain name Shared Registration System (SRS) based on their TLD. TLDs may also be referred to as domain name extensions.

The process for registering a domain name with .com, .net, .org, and some other TLD allows a website operator (such as the client 100 in FIG. 1) to use an ICANN-accredited Registrar to register their domain name. For example, if a website operator, John Doe, wishes to register the domain name “mycompany.com,” John Doe may initially determine whether the desired domain name is available by contacting a domain name registrar. The website operator may make this contact using the Registrar's webpage and typing the desired domain name into a field on the registrar's webpage created for this purpose. Upon receiving the request from the website operator, the Registrar may ascertain whether “mycompany.com” has already been registered by checking the SRS database associated with the TLD of the domain name and/or by checking with the Registry. The results of the search then may be displayed on the webpage to thereby notify the website operator of the availability of the domain name. If the domain name is available, the website operator may proceed with the registration process. If the domain name is not available for registration, the website operator may keep selecting alternative domain names until an available domain name is found.

A reverse proxy server 110 may be a type of server that retrieves resources on behalf of a client 100 from one or more hosting servers 150, 160, 170. These resources may then be returned to the client 100 as though they originated from one or more of the servers 150, 160, 170. A reverse proxy server 110 may act as an intermediary for its hosting servers 150, 160, 170 and only returns resources provided by those hosting servers 150, 160, 170.

Reverse proxy servers 110 may hide the existence and characteristics of the origin hosting server(s) 150, 160, 170. Application firewall features on a reverse proxy server 110 may protect against common web-based attacks. Without a reverse proxy server 110, removing malware or initiating takedowns, for example, may be more difficult. A reverse proxy server 110 may distribute the load from incoming requests to several hosting servers 150, 160, 170, with each hosting server 150, 160, 170 serving its own application area. A reverse proxy server 110 may reduce load on its origin hosting servers 150, 160, 170 by caching static and dynamic content.

The reverse proxy server 110 may comprise, as non-limiting examples, one or more hardware servers 120, such as Dell PowerEdge(s) rack server(s), HP Blade Servers, IBM Rack or Tower servers, although other types of servers and/or combinations of one or more servers may also be used. Software 130 and applications may be run on the reverse proxy server 110.

The software 130 preferably also comprise domain name routing rules 140. The domain name routing rules 140 may receive a domain name and optionally a path (possibly in a header of an HTTP request received by the reverse proxy server 110) as an input and provide an address to the reverse proxy server 110 to facilitate locating a website or website resource on one or more hosting servers 150, 160, 170.

As a non-limiting example, the domain name routing rules 140 may receive a domain name a.com 151, from a request to the reverse proxy server 110, and the domain name routing rules 140 may provide an address to a website or a website resource a.com 151 in a hosting server 150. A similar process may be used by the domain name routing rules 140 for a plurality of domain names, such as a.com 151, b.com 152, c.com 161, d.com 162, e.com 163 and f.com 171 to point to, locate or provide an address to a plurality of corresponding websites or website resources such as a.com 151, b.com 152 in hosting server 150, c.com 161, d.com 162 and e.com 163 in hosting server 160 and f.com 171 in hosting server 170. In practice, any number of domain names (and optionally paths) and hosting servers may be used.

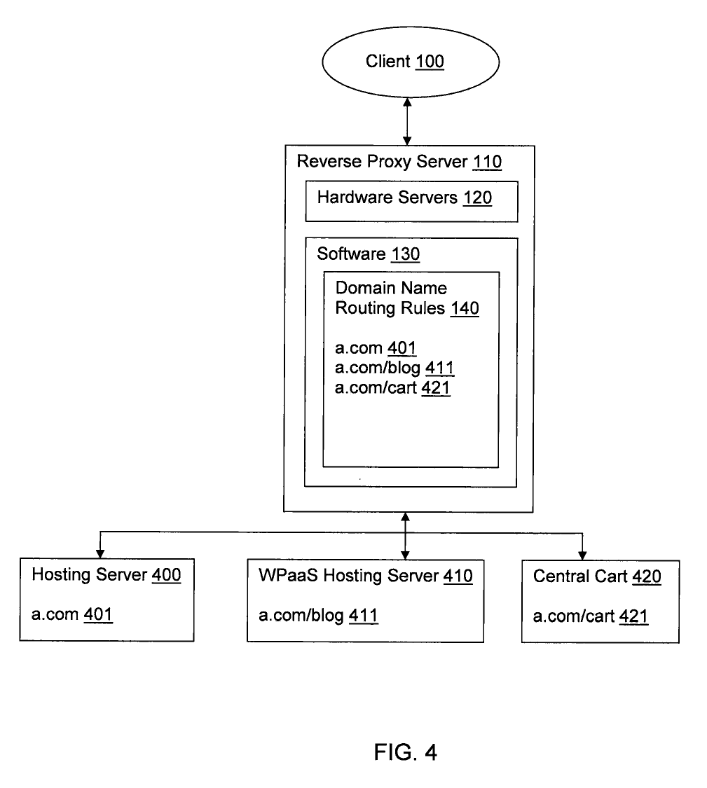

FIG. 4 illustrates another embodiment for domain name routing rules 140. As a non-limiting example, the domain name routing rules 140 may receive a domain name and a path, such as a.com/blog 411 or a.com/cart 421 from a request to reverse proxy server 110, and the domain name routing rules 140 may provide an address to a website or website resource, such as a.com/blog 411 in Workplace as a Service (WPaaS) hosting server 410 or a.com/cart 421 in Central Cart hosting server 420.

An example method of practicing the invention will now be described with reference to FIGS. 1-5. A client 100 or customer may register a domain name and purchase hosting services on one or more hosting servers 150, 160, 170. A hosting administrator may set up the one or more hosting servers 150, 160, 170 in preparation for providing hosting services and configure a reverse proxy server 110 for the domain name to route incoming requests to the purchased hosting services on the one or more hosting servers 150, 160, 170. The customer or client 100 may host a website or website resources, such as, as non-limiting examples, SSL, blogs, shopping carts, etc., on the hosting servers 150, 160, 170.

The hosting administrator may generate and store, on the reverse proxy server 110 (possibly for a cluster of servers or hosting servers 150, 160, 170), a set of domain name routing rules 140. The domain name routing rules 140 may be part of any proprietary or open source software for fulfilling a request, wherein the request may be, as non-limiting examples, configuring, routing and/or load balancing a server cluster. The server cluster may comprise the one or more hardware servers 150, 160, 170. The domain name routing rules 140 may identify the individual IP for each hosting server 150, 160, 170 in the server cluster, the website content stored on each hosting server 150, 160, 170 by domain name and where traffic to the website should be directed based on the domain name, the individual IPs and/or a path.

The reverse proxy server 110 may receive an incoming request, such as an HTTP request, related to the website or website resource. The domain name routing rules 140 may instruct the reverse proxy server 110, rather than accessing the Domain Name System (DNS), to analyze the request packet to identify the domain name. The reverse proxy server 110 may identify the domain name within a header of the request (inspects the application layer—OSI layer seven for example). The reverse proxy server 110 may consult the domain name routing rules 140 to determine the server resources, such as hosting servers 150, 160, 170, to be used and the action to take to fulfill the request.

The action to fulfill the request may be moving website files from one server to another, but using a domain name, rather than the DNS, to do it. Because the DNS is not used, the perceived change of files from one resource to another is instantaneous (i.e., no delay because of DNS updates). For example, if a.com 151 and b.com 152 want half a hosting server 150, a.com 151 and b.com 152 could share a hosting server 150 without changing the DNS. This change may be accomplished by changing the domain name routing rules 140 that directs the traffic on the proxy tier (reverse proxy server 110) rather than changing the DNS.

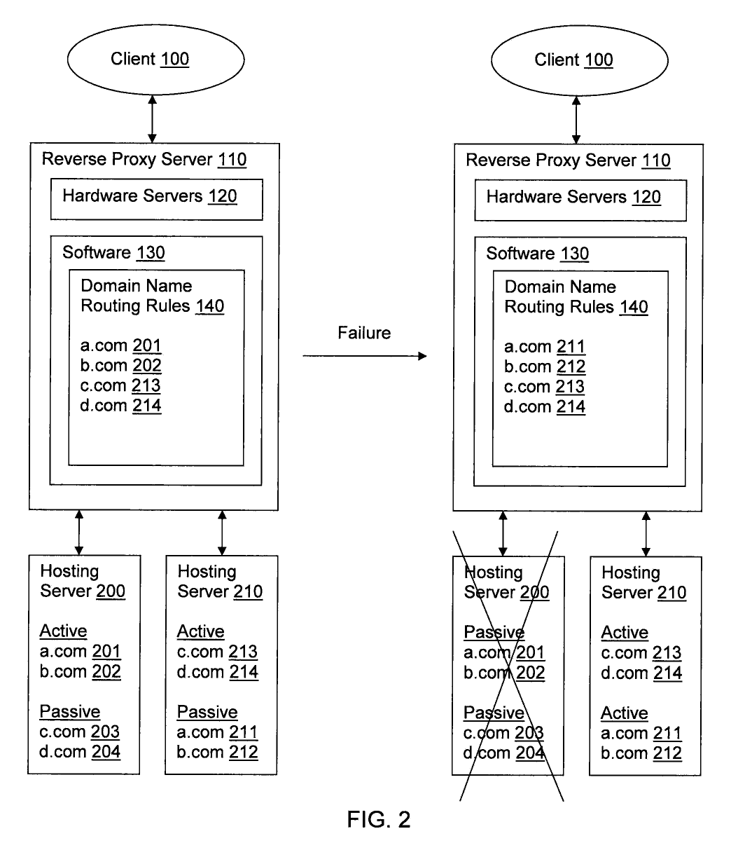

The action to fulfill the request may be allocating resources on a passive server to be activated when an active site(s)/hosting server(s) fail (i.e. failover using the domain name as a routable construct). An example is shown in FIG. 2. The domain name routing rules may activate the site on another node or hosting server 150, 160, 170. The domain name routing rules 140, rather than IP addresses, may be used to change the pointer in the reverse proxy server 110 so that it points to the node or hosting server 150, 160, 170 where the website or website resource is to be activated.

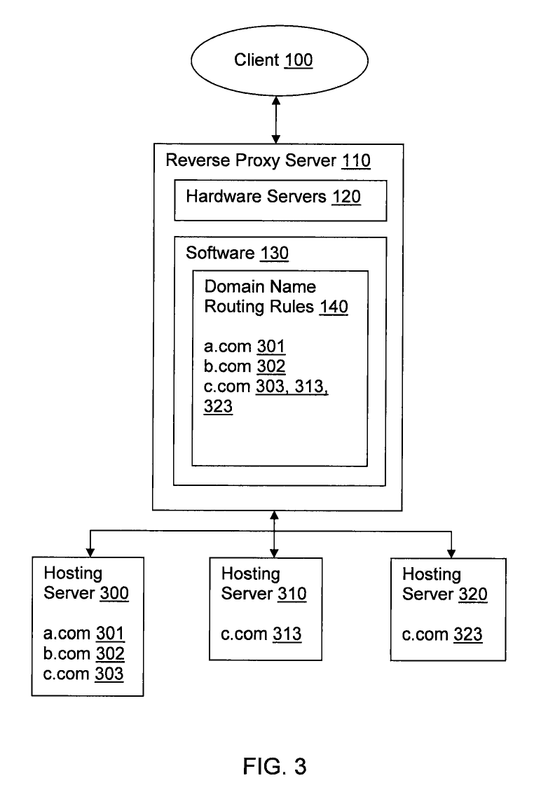

The action to fulfill the request may be to provide a website or website resource that spans two or more hosting servers 150, 160, 170 using any method, such as, as a non-limiting example, Infrastructure as a Service (IaaS). An example is shown in FIG. 3 where a client 100 registering the domain name c.com has purchased hosting services on 2⅓ hosting servers 300, 310, 320. To route the traffic for these hosting servers 300, 310, 320, all three hosting servers 300, 310, 320 may be routed from one domain name, e.g., c.com 303, 313, 323. Each node or hosting server 300, 310, 320 in the cluster may run a private IP, which the reverse proxy server 110 may recognize due to the domain name routing rules 140.

The action to fulfill the request may be to use reusable cache for website content on a cluster server nodes, rather than on the reverse proxy server 110. Rather than caching the reverse proxy server 110, or caching files spanning all servers for a customer or client 100, the website resources, such as files, for the allocation on the server may be cached on the server that has the file allocation. This may be an efficiency measure, as the load is not spread that doesn't need to be spread.

Some embodiments may improve the Search Engine Optimization (SEO) ranking by eliminating subdomains and redirect usage for a website or a website resource. Subdomains are often used to route request to multiple services on the same domain name. SEO tends to give subdomains a reduced value in points compared to root domain names. Using domain names as a routable construct in domain name routing rules 140 allows use of domain name paths to different services on different resources.

FIG. 4 illustrates an example where the domain name routing rules 140 may be written to recognize that a.com/blog is on a completely different hosting server 400, 410, 420 from a.com or a.com/cart and direct traffic to the correct service. This may allow different services on different hosting servers 400, 410, 420 to be combined together under one domain name (a.com in this example) without using subdomains or redirects, but still directing to safe locations to process transactions. This approach may be more efficient than hosting secure/non-secure content/services on the same hosting server 400, 410, 420 or website. SEO values may also be higher because subdomain are not being used. In addition, to the client 100 all the services look like one common service and/or website, but the reverse proxy server 110 uses the domain name and optionally a path to access SSL, cart services or any other website services or resources on one or more hosting servers 400, 410, 420.

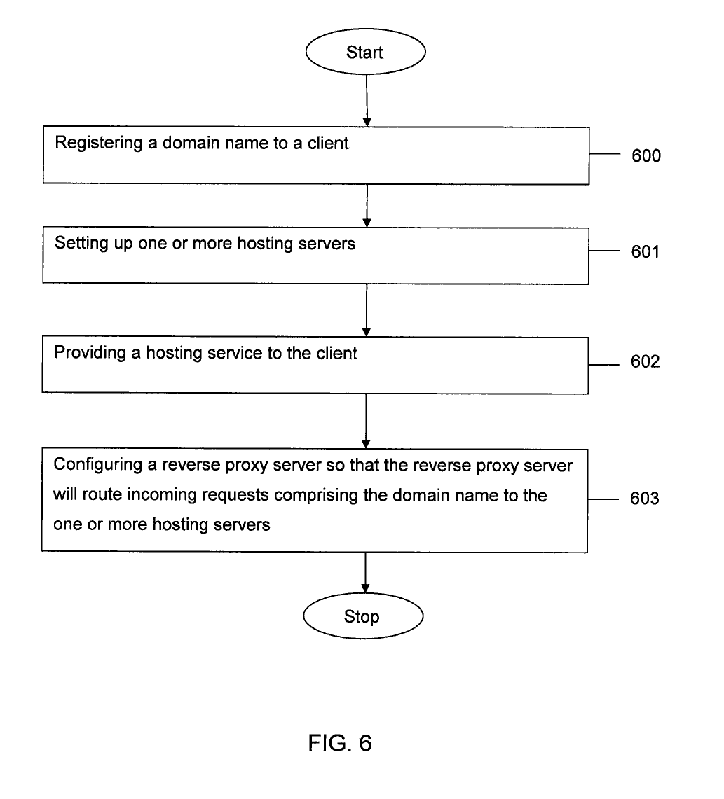

FIG. 6 illustrates an example method for practicing the invention. A domain name, for example a.com, may be registered to a client 100. (Step 600) Hosting server(s) 150, 160, 170 may be set up in preparation for providing hosting services. (Step 601) Hosting services (such as hosting a website or website resource a.com 151 on hosting server 150) on one or more hosting servers 150, 160, 170 may also be provided to the client 100. (Step 602) A reverse proxy server 110 may be configured so that the reverse proxy server 110 will route incoming requests comprising a domain name, such as a.com 151, to a website or website resource (a.com 151) located on one or more hosting servers 150. (Step 603)

To facilitate the routing, the reverse proxy server 110 may include domain name routing rules 140 for a plurality of domain names (a.com 151, b.com 152, c.com 161, d.com 162, e.com 163 and f.com 171), wherein the domain name routing rules 140 may receive a domain name and determine an address or location of a website or website resource on one or more hosting servers 150, 160, 170. Specifically, if the domain name routing rules 140 received the domain name a.com 151, the domain name routing rules 140 may point to website or website resource a.com 151 on hosting server 150.

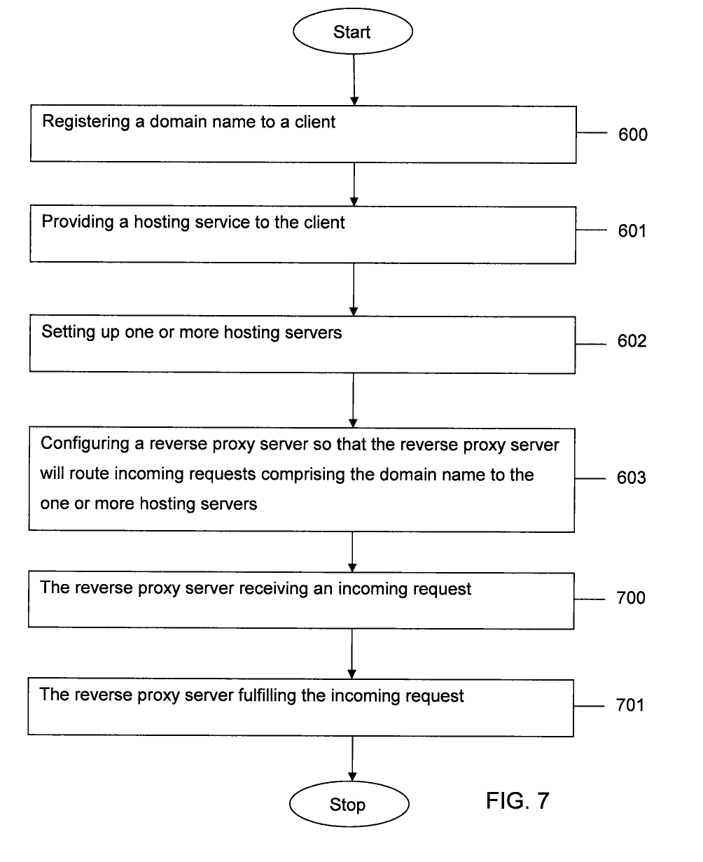

FIG. 7 illustrates another example method for practicing the invention. This embodiment includes the method illustrated in FIG. 6, but further includes the steps of the reverse proxy server 110 receiving an incoming request (Step 700) and then fulfilling the incoming request (Step 701). In some embodiments, the incoming request may comprise a request to move a website file from a first server 150 in the one or more hosting servers 150, 160, 170 to a second server 160 in the one or more hosting servers 150, 160, 170. As shown in FIG. 2, in some embodiments the incoming request may comprise a request to activate passive resources a.com 211, b.com 212 on a first hosting server 210 in the one or more hosting servers 200, 210 and deactivate active resources a.com 201 and b.com 202 on a second server 200 in the one or more hosting servers 200, 210.

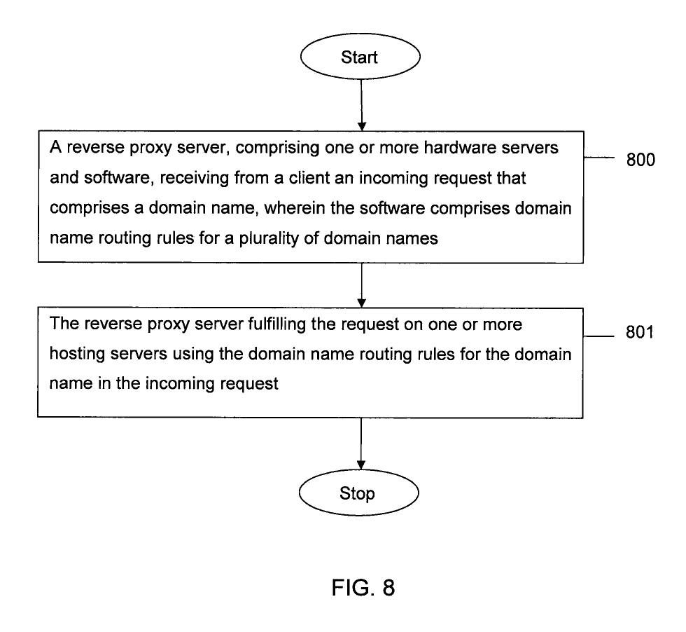

FIG. 8 illustrates another example method for practicing the invention. A reverse proxy server 110 may receive from a client 100 an incoming request that has a domain name. The reverse proxy server 110 may comprise software that includes domain name routing rules 140 for a plurality of domain names. (Step 800) The reverse proxy may fulfill the incoming request on one or more hosting servers 150, 160, 170 using the domain name routing rules for the domain name in the incoming request to determine a website or website resource located on the one or more hosting servers 150, 160, 170. (Step 801) The incoming request may be an HTTP request.

In other embodiments, the incoming request has a domain name and a path, such as a.com/blog 411, as illustrated in FIG. 4, so the domain name routing rules 140 may locate the associated website resource a.com/blog 411 in the WPaaS Hosting Server 410. The software 130 may comprise domain name routing rules 140 for a plurality of domain names 401 and one or more domain names, in the plurality of domain names, may each be associated with one or more paths.

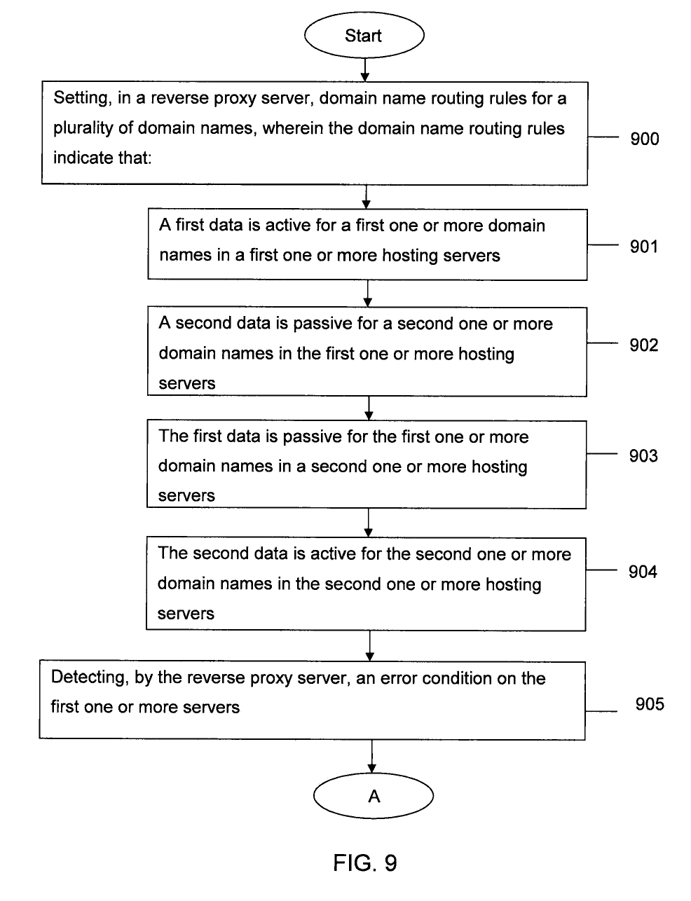

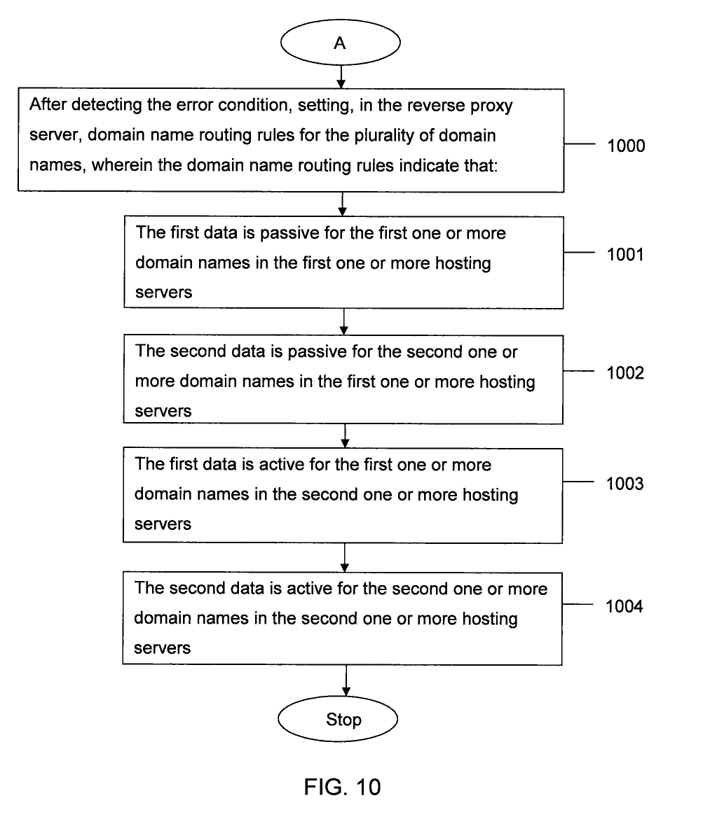

FIGS. 2, 9 and 10 illustrate another example embodiment for practicing the invention. This embodiment allows for a method that includes redundancy and provides for an automatic failover in the event of an error condition. The reverse proxy server 110 may set domain name routing rules 140 (Step 900) to indicate that: a first data is active for a first one or more domain names (a.com 201 and b.com 202) in a first one or more hosting servers (hosting server 200) (Step 901); a second data is passive for a second one or more domain names (c.com 203, d.com 204) in the first one or more hosting servers (hosting server 200) (Step 902); the first data is passive for the first one or more domain names (a.com 211 and b.com 212) in a second one or more hosting servers (hosting server 210) (Step 903); and the second data is active for the second one or more domain names (c.com 213 and d.com 214) in the second one or more hosting servers (hosting server 210) (Step 904).

The reverse proxy server 110 may detect an error condition on one or more of the hosting servers 200, 210, such as, as an example, the hosting server 200. (Step 905)

After detecting the error condition, the reverse proxy server 110 may reset or rewrite the domain name routing rules 140 for the plurality of domain names (Step 1000), wherein the domain name routing rules 140 indicate that: the first data is passive for the first one or more domain names (a.com 201 and b.com 202) in the first one or more hosting servers (hosting server 200) (Step 1001); the second data is passive for the second one or more domain names (c.com 203 and d.com 204) in the first one or more hosting servers (hosting server 200) (Step 1002); the first data is active for the first one or more domain names (a.com 211 and b.com 212) in the second one or more hosting servers (hosting server 210) (Step 1003); and the second data is active for the second one or more domain names (c.com 213 and d.com 214) in the second one or more hosting servers (hosting server 210) (Step 1004).

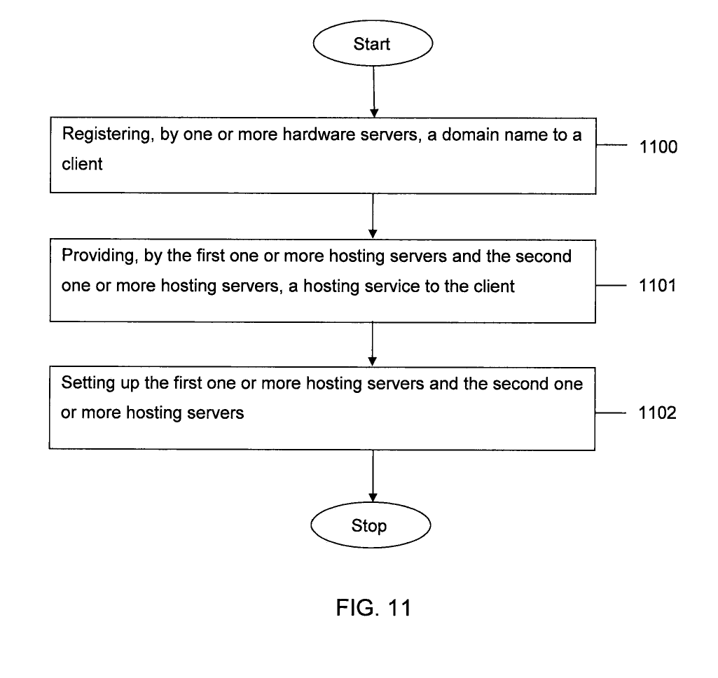

FIG. 11 illustrates additional steps that may taken by themselves or combined with other embodiments. One or more hardware servers may register a domain name to a client 100. (Step 1100). A first one or more hosting servers 200 and a second one or more hosting servers 210 may provide hosting services to the client 100. (Step 1101) The first one or more hosting servers 200 and the second one or more hosting servers 210 may be set up in preparation for providing hosting services. (Step 1102) In some embodiments, the reverse proxy server 110 (comprising one or more hardware servers and software) may receive an incoming request that comprises a domain name in a plurality of domain names and fulfills the incoming request on the first one or more hosting servers 200 or on the second one or more hosting servers 210 using the domain name routing rules 140 for the domain name in the incoming request.

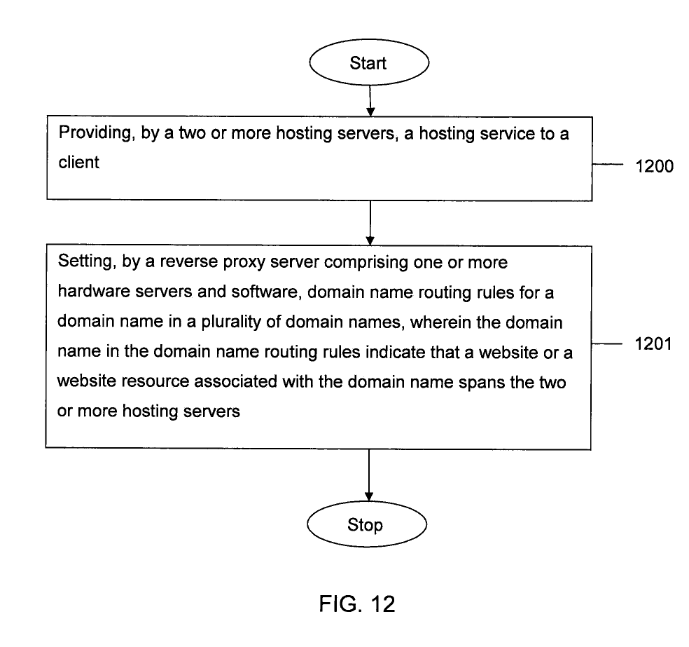

FIGS. 3 and 12 illustrate another example method for practicing the invention. Two or more hosting servers 300, 310, 320 may provide a hosting service to a client 100. (Step 1200) A reverse proxy server 110 may set domain name routing rules 140 for a domain name, such as c.com 303, 313, 323, in a plurality of domain names, wherein the domain name c.com 303, 313, 323 in the domain name routing rules 140 indicate that a website or a website resource associated with the domain name c.com 303, 313, 323 spans the two or more hosting servers 300, 310, 320. (Step 1201) In other embodiments, one or more hardware servers may be used to register the domain name c.com to the client 100. In yet other embodiments, the reverse proxy server 110 may receive an incoming request that comprises the domain name c.com (as an example) and fulfill the incoming request on the two or more hosting servers 300, 310, 320 using the domain name routing rules 140 for the domain name c.com in the incoming request.

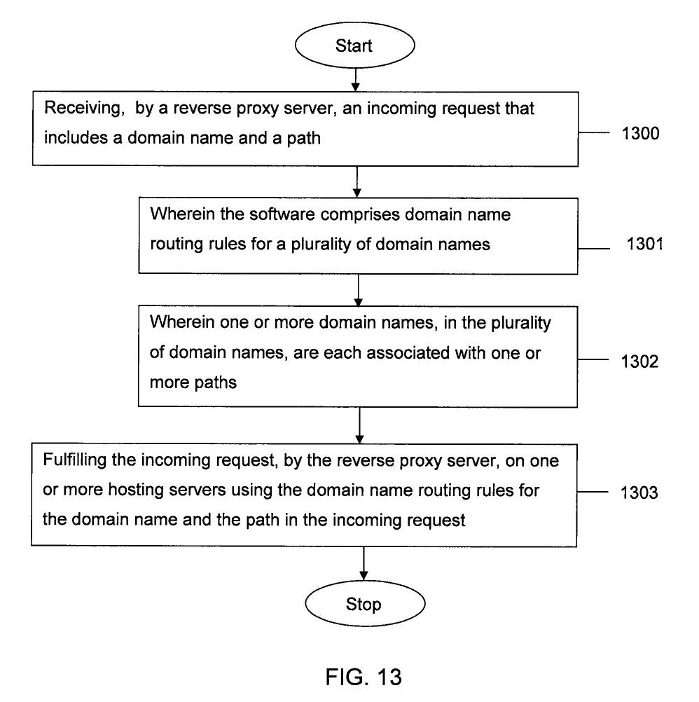

FIGS. 4 and 13 illustrate an example embodiment for an integrated product and/or service for practicing the invention. In this embodiment a reverse proxy server 110 may receive an incoming request (such as an HTTP request) that includes a domain name and a path. (Step 1300) Non-limiting examples of a domain name and a path are a.com/blog 411, where a.com is the domain name and /blog is the path and a.com/cart 421, where a.com is the domain name and /cart is the path. The domain name routing rules 140 may point, locate or identify an address given the domain name and the path in the incoming request. (Step 1301) For example, if a.com/blog were received by the reverse proxy server 110 in an incoming request, the domain name routing rules 140 may point to a.com/blog 411 on the WPaaS hosting server 410. (Step 1302) The reverse proxy server 110 may fulfill the incoming request on one or more hosting servers using the domain name routing rules 140 for the domain name and the path in the incoming request. (Step 1303)

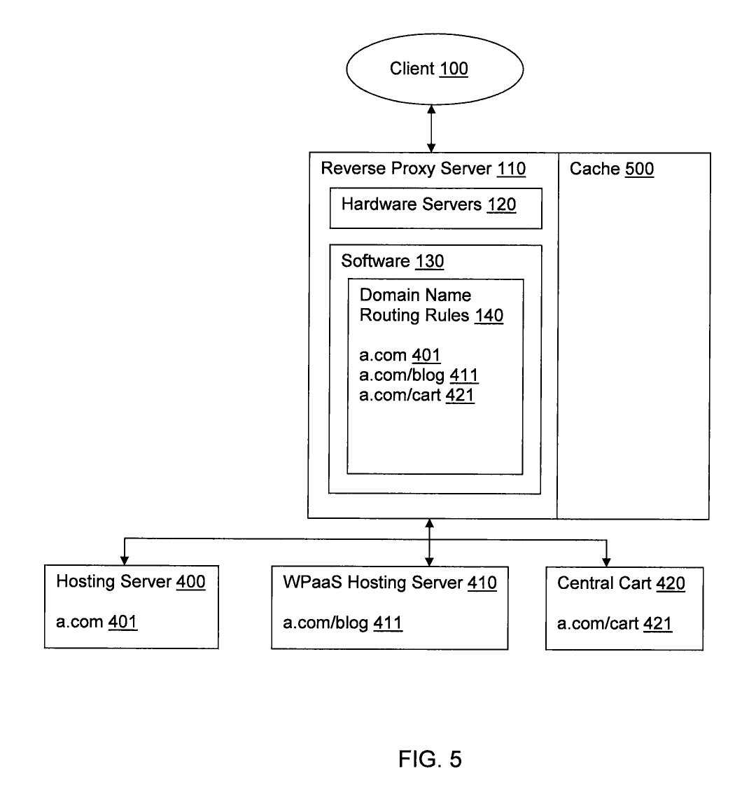

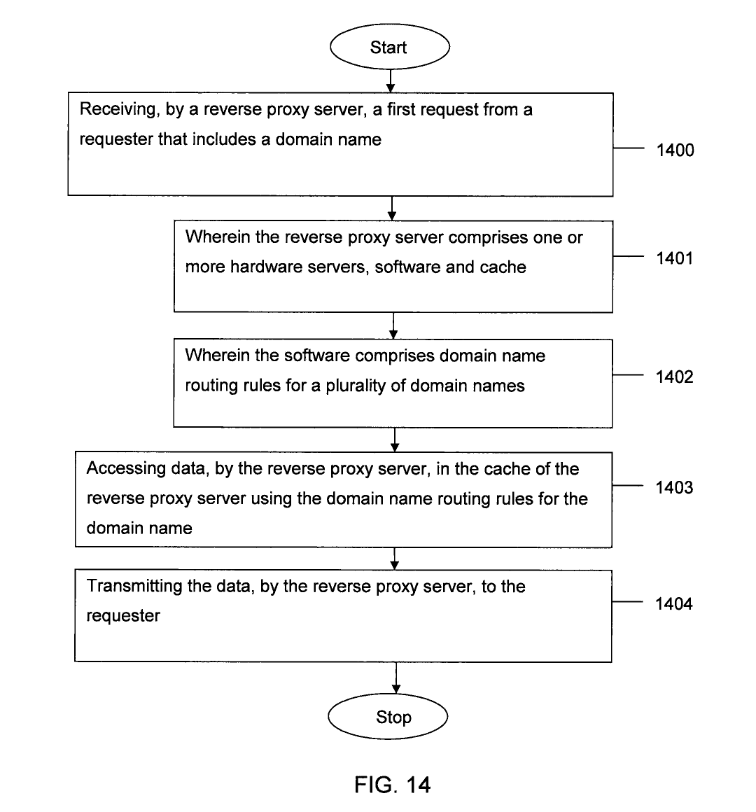

FIGS. 5 and 14 illustrate an example embodiment for using cache 500 on the reverse proxy server 110 to practice the invention. The reverse proxy server 110 may receive a first request (possibly an HTTP request) from a requester (who could be client 100) that includes a domain name. (Step 1400) The reverse proxy server 110 may comprise one or more hardware servers 120, software 130 and cache 500. (Step 1401) The software may comprise domain name routing rules 140 for a plurality of domain names. (Step 1402) The reverse proxy server 110 may access data in the cache 500 of the reverse proxy server 110 using the domain name routing rules 140 for the domain name. (Step 1403) The reverse proxy server 110 may transmit the data from cache 500 to the requester. (Step 1404)

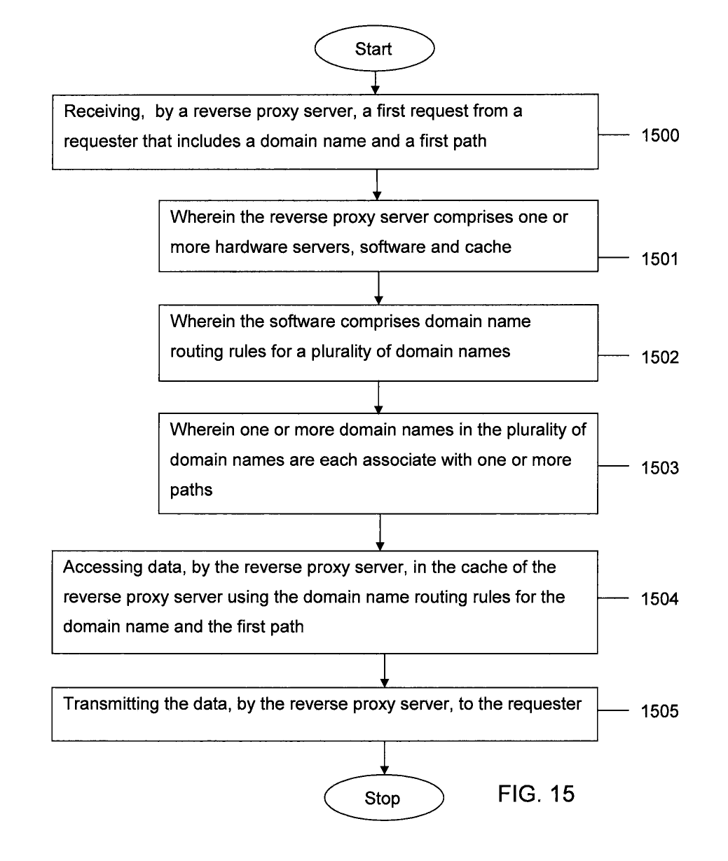

FIG. 15 illustrates an example embodiment for using cache 500 on the reverse proxy server 110 to practice the invention. The reverse proxy server 110 may receive a first request (possibly an HTTP request) from a requester that includes a domain name and a path. (Step 1500) The reverse proxy server 110 may comprise one or more hardware servers 120, software 130 and cache 500. (Step 1501) The software may comprise domain name routing rules 140 for a plurality of domain names (Step 1502), wherein one or more of the domain names in the plurality of domain names may have one or more paths. (Step 1503) As an example, FIG. 5 shows that domain name a.com may be associated with path /blog to form a.com/blog 411 and a.com may be associated with path /cart to form a.com/cart 421. The reverse proxy server 110 may access data in the cache 500 of the reverse proxy server 110 using the domain name routing rules 140 for the domain name and the path without accessing a hosting server 400, 410, 420. (Step 1504) The reverse proxy server 110 may transmit the data from the cache 500 to the requester. (Step 1505)

It should be understood that teachings from any embodiment herein described may be combined with teachings from any other embodiment herein described, unless explicitly stated otherwise. As an example, any embodiment described herein using a domain name with domain name routing rules may also use a domain name and a path with the domain name routing rules.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method for allocating and controlling resources, comprising the steps of:
a) registering, by one or more hardware servers, a domain name to a client;
b) providing, by one or more hosting servers, a hosting service to the client; and
c) configuring a reverse proxy server so that the reverse proxy server will route incoming requests comprising the domain name to the one or more hosting servers.

2. The method of claim 1, wherein the reverse proxy server comprises one or more hardware servers and software and wherein the software comprises domain name routing rules for a plurality of domain names.

3. The method of claim 2, wherein the software comprises domain name routing rules for the plurality of domain names and one or more domain names in the plurality of domain names is associated with one or more paths.

4. The method of claim 1, further comprising the step of:
d) hosting website content on the one or more hosting servers.

5. The method of claim 1, further comprising the steps of:
d) receiving, by the reverse proxy server, an incoming request; and
e) fulfilling, by the reverse proxy server, the incoming request.

6. The method of claim 5, wherein the incoming request comprises a request to move a website file from a first server in the one or more hosting servers to a second server in the one or more hosting servers.

7. The method of claim 5, wherein the incoming request comprises a request to activate passive resources on a first server in the one or more hosting servers and deactivate active resources on a second server in the one or more hosting servers.

8. A method for allocating and controlling resources, comprising the steps of:
a) receiving, by a reverse proxy server comprising one or more hardware servers and software, from a client an incoming request that comprises a domain name, wherein the software comprises domain name routing rules for a plurality of domain names; and
b) fulfilling the incoming request, by the reverse proxy server, on one or more hosting servers using the domain name routing rules for the domain name in the incoming request.

9. The method of claim 8, wherein the incoming request comprises an HTTP request.

10. The method of claim 8, wherein the incoming request comprises the domain name and a path.

11. The method of claim 8, wherein the software comprises domain name routing rules for the plurality of domain names and one or more domain names, in the plurality of domain names, is each associated with one or more paths.

12. The method of claim 8, further comprising the step of:
c) hosting website content on the one or more hosting servers.

13. The method of claim 8, wherein the incoming request comprises a request to move a website file from a first server in the one or more hosting servers to a second server in the one or more hosting servers.

14. The method of claim 8, wherein the incoming request comprises a request to activate passive resources on a first server in the one or more hosting servers and deactivate active resources on a second server in the one or more hosting servers.

15. A method for redundancy and automatic failover, comprising the steps of:
a) setting, in a reverse proxy server, domain name routing rules for a plurality of domain names, wherein the domain name routing rules indicate that:
i) a first data is active for a first one or more domain names in a first one or more hosting servers;
ii) a second data is passive for a second one or more domain names in the first one or more hosting servers;
iii) the first data is passive for the first one or more domain names in a second one or more hosting servers; and
iv) the second data is active for the second one or more domain names in the second one or more hosting servers;
b) detecting, by the reverse proxy server, an error condition on the first one or more servers; and
c) after detecting the error condition, setting, in the reverse proxy server, domain name routing rules for the plurality of domain names, wherein the domain name routing rules indicate that:
i) the first data is passive for the first one or more domain names in the first one or more hosting servers;
ii) the second data is passive for the second one or more domain names in the first one or more hosting servers;
iii) the first data is active for the first one or more domain names in the second one or more hosting servers; and
iv) the second data is active for the second one or more domain names in the second one or more hosting servers.

16. The method of claim 15, further comprising the steps of:
d) registering, by one or more hardware servers, the domain name to a client;
e) providing, by the first one or more hosting servers and the second one or more hosting servers, a hosting service to the client; and
f) setting up the first one or more hosting servers and the second one or more hosting servers.

17. The method of claim 15, further comprising the steps of:
d) receiving, by the reverse proxy server comprising one or more hardware servers and software, an incoming request that comprises a domain name in the plurality of domain names; and
e) fulfilling the incoming request, by the reverse proxy server, on the first one or more hosting servers or on the second one or more hosting servers using the domain name routing rules for the domain name in the incoming request.

18. A method for account spanning, comprising the steps of:
a) providing, by two or more hosting servers, a hosting service to a client; and
b) setting, by a reverse proxy server comprising one or more hardware servers and software, domain name routing rules for a domain name in a plurality of domain names, wherein the domain name in the domain name routing rules indicate that a website or a website resource associated with the domain name spans the two or more hosting servers.

19. The method of claim 18, further comprising the steps of:
c) registering, by one or more hardware servers, the domain name to the client; and
d) setting up the two or more hosting servers.

20. The method of claim 18, further comprising the steps of:
c) receiving, by the reverse proxy server, an incoming request that comprises the domain name in the plurality of domain names; and
d) fulfilling the incoming request, by the reverse proxy server, on the two or more hosting servers using the domain name routing rules for the domain name in the incoming request.
